(19) United States
(12) Patent Application Publication
(10) Pub. No.: US 2004/0137942 A1
(43) Pub. Date: Jul. 15, 2004

(54) Data gathering bus terminal controlled and monitored remotely using RF communications network, and data gathering system using the bus terminal

(76) Inventors: Sang-Uk Lee, Daejeon-city (KR); Jae-Hoon Kim, Daejeon-city (KR); Seong-Pal Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/745,877

(22) Filed: Dec. 24, 2003

(30) Foreign Application Priority Data
Dec. 24, 2002 (KR) 10-2002-0083724

(51) Int. Cl. H04M 1/00; H04B 1/38

(52) U.S. Cl. 455/556.1; 455/557

(57) ABSTRACT

Disclosed is a date gathering bus terminal using an RF network and a data gathering system using the bus terminal. The bus terminal connected with a measuring device via a standard adapter and connected to a central control/processing center through an network comprises a standard interface adapter for receiving gathered data from the measuring device; a data processing subsystem for processing data gathered by the adapter; and a reception and transmission subsystem for transmitting the processed data and state of health data of the bus terminal and the measuring device to the central control/processing center, and receiving control signals for the bus terminal and the measuring device from central control/processing center.

### CROSS REFERENCE TO RELATED APPLICATION

This application claims priority to and the benefit of Korea Patent Application No. 2002-83724 filed on Dec. 24, 2002 in the Korean Intellectual Property Office, the content of which is incorporated herein by reference.

### BACKGROUND OF THE INVENTION

(a) Field of the Invention

The present invention relates to a generalized date gathering bus terminal controlled and monitored remotely using RF communications network and a data gathering system using the bus terminal. More specifically, the present invention relates to a bus terminal for gathering and transmitting data measured by a plurality of measuring devices, and a data gathering system using the bus terminal.

(b) Description of the Related Art

Generally, various kinds of data varied in the daily life such as temperature, power variations, environmental data measured by many measuring devices are transmitted to a central processing center via various transmitters.

For example, CCD image data taken in a specified area for security purpose is transmitted to the central data processing center via a dedicated line. Also, National Climate and Meteorological Office uses dedicated lines or the ORBCOM satellite network for gathering meteorological data.

Since each data gathering system utilizes a different infrastructure, there are weak points such as resource wastes, less compatibility between data for different systems, and less sharing and utilization.

### SUMMARY OF THE INVENTION

It is an advantage of the present invention to provide a data gathering system for gathering data from various measuring devices and transmitting gathered data by the generalized bus terminal.

It is another advantage of the present invention to provide a data gathering system for gathering data from various measuring devices using a is bus terminal and analyzing the data.

In one aspect of the present invention, a bus terminal coupled to a central control/processing center through an RF (radio frequency) communications network comprises: an adapter coupled to a measuring device, for receiving data measured by the measuring device; a data processing subsystem for processing the data gathered by the adapter and state of health data of the measuring device and the bus terminal; a transmission and reception subsystem for transmitting the processed data and control commands for controlling the bus terminal and the measuring device to the central control/processing center through the RF communications network; and a power supply subsystem for supplying power to the bus terminal.

The adapter converts the data provided by the measuring device into digital signals, and provides the digital signals to the data processing subsystem, and receives data from the measuring device through an interface including the RS232 and the RS422.

The data processing subsystem comprises: a data gathering module for gathering the measured data provided by the measuring device through the adapter and the state of health data of the measuring device and generating state of health data of the bus terminal; a data storing module for storing the measuring data and the state of health data; a data processing module for processing the data provided by the data gathering module and the data stored in the data storing module in a predefined format; and a control module for controlling the data gathering and processing procedures, and controlling the operations of the bus terminal and the measuring device.

The control module controls operations of the bus terminal and the measuring device according to telecommands transmitted from the central control/processing center through the RF communications network, controls the transmission and reception subsystem according to a preset period and a request by the central control/processing center, and transmits the processed data to the central control/processing center, and also controls the format of the transmitted data.

The power supply subsystem further comprises: an external power supply module including a solar array for supplying power to the bus terminal; a battery for supplying power to the bus terminal when the external power supply module supplies no power; and a power control module for controlling supply of power of the battery and the external power supply, and wherein the external power supply module charges the battery and further comprises a battery for supplying power at the time of power failure and a diode.

In another aspect of the present invention, a bus terminal comprising a transmission and reception subsystem for transmitting data packets of a specific format received from a data processing subsystem to a central in control/processing center through an RF (radio frequency) communications network, and transmitting telecommands received from the central control/processing center to a control subsystem of a data processing subsystem.

The central control/processing center determines states of the measuring device and the bus terminal based on received state of health data, issues telecommands based on state of health of the bus terminal and the measuring device and processes telecommands in a predefined format, and transmits the same to the bus terminal through the RF communications network, and the bus terminal accepts the operations executed by the central control/processing center.

In still another aspect of the present invention, a data gathering system connected to an RF (radio frequency) communications network, for gathering data measured by a measuring device, comprises: at least one bus terminal including an adapter for receiving the measured data from the measuring devices, a data processing subsystem for processing the data received by the adapter, a transmission and reception subsystem for transmitting the processed data through the RF communications network and receiving control commands, and a power supply subsystem for supplying electrical power to the bus terminal; and a central control/processing center connected to the bus terminal through the RF communications network, for receiving the data transmitted from the bus terminal and processing the same.

The bus terminal generates state of health data for showing operation states of the bus terminal and the measuring device, and transmits them together with the measured data to the central control/processing center through the RF communications network, and the central control/processing center monitors states of the bus terminal and the measuring device based on the state of health data, and processes the resultant control telecommands into a predefined format, and transmits the same to the bus terminal through the RF communications network.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a whole configuration diagram of a data gathering system according to a preferred embodiment of the present invention;

FIG. 2 is a structure of a data gathering bus terminal according to a preferred embodiment of the present invention; and

FIG. 3 is a flowchart of a data gathering sequence according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

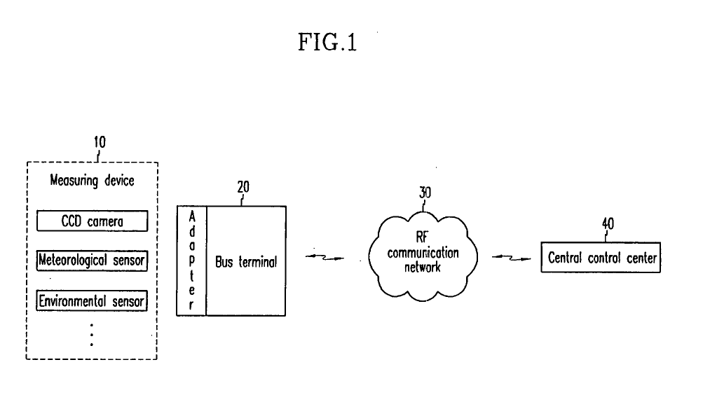

FIG. 1 is a whole configuration of a data gathering system according to a preferred embodiment of the present invention.

As shown, a plurality of measuring devices 10 such as a CCD camera are equipped on the data gathering bus terminal 20, and the bus terminal 20 is connected to a central control/processing center 40 through an RF (radio frequency) communications network 30.

The bus terminal 20 is operated by a telecommand from the central control/processing center 40 or a self-contained control command, gathers and processes the data gathered by the measuring device 10, and transmits the measured data together with state-of-health data to the central control/processing center 40 via commercial RF communications network 30. These kinds of the bus terminal 20 and the measuring device 10 can be plural.

The bus terminal 20 has following characteristics.

1) The above-noted bus terminal transmits the measured data gathered from the remote measuring devices and the state of health data of the measuring devices and the bus terminal. The gathered data converted into specific format data are transmitted to the central control/processing center through the RF communications network.

2) The bus terminal includes a standard shape and protocol adapter (or an interface) with various measuring devices and sensors. In particular, the measuring devices can be equipped to the bus terminal by the adapter.

3) The bus terminal uses an external power supply if available and if not, a solar array is used to charge the battery and directly supply the power.

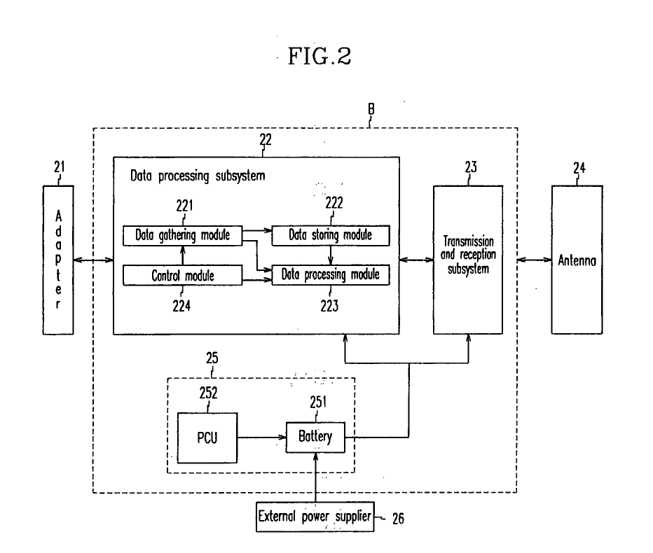

FIG. 2 shows a configuration of the bus terminal according to a preferred embodiment of the present invention.

As shown, the bus terminal 20 includes an adapter 21 that is connected to the measuring devices and receives the measured data; a data processing subsystem 22 for processing the data gathered by the adapter, a transmission and reception subsystem 23 for transmitting the processed data and the state of health data of the measuring devices and the bus terminal to the central control/processing center 40 to receive a control command from the central control/processing center via the RF communications network; an antenna 24, and an electrical power subsystem 25 for providing required power to the respective subsystems.

The adapter 21 provides a standard and specific shape interface with various measuring devices 10, and the data processing subsystem processes the data transmitted via the interface so that the data may be transmitted. The data processing subsystem 22 includes: a data gathering module 221 for gathering measured data provided from measuring devices 10 via the adapter 21 and state of health data of the measuring devices 10, and generating state of health data of the bus terminal; a data storing module 222 for storing the measured data and the state of health data of the measuring devices and the bus terminal; a data processing module 223 for converting the measured data into a desired format, and a control module 224 for controlling the data gathering and processing procedures. The control module 224 includes an OBC (on board computer).

The transmission and reception subsystem 23 transmits the data processed and output by the above-structured data processing subsystem 22 to the central control/processing center 40 via the RF communications network 30 or provide the telecommand received from the central control/processing center 40 to the data processing subsystem 22. For instance, the transmission and reception subsystem may include an RF module for receiving RF signals from the central control/processing center 40 via the RF communications network 30 and converting the data provided from the data processing subsystem 22 into RF signals for transmission; and a baseband processing module for demodulating the signals received from the RF module, and modulating desired data to transmit them.

The electrical power subsystem 25 supplies required electrical power for operation of the bus terminal, and includes a battery 251, a PCU (power control unit) module 252, and an external electrical power supplier 26 for charging the battery 251. In particular, the external power supply subsystem 25 is a battery, and without being restricted to the battery, it also includes other power supplies for supplying the electrical power to the bus terminal and the battery. Also, for example, the external power supplier may further include a battery for supplying power to the bus terminal at an electrical power failure, and a diode for preventing instability of currents.

The bus terminal body B may include a data processing subsystem 22 and an electrical power supply subsystem 25.

The central control/processing center 40 monitors the state of health of the bus terminal 20 based on the data in a specific format, and transmits a telecommand of the predefined format to the bus terminal 20 and the measuring devices 10 so as to control their operation.

Data communication between the central control/processing center 40 and the bus terminal 20 is performed in a predefined period, in real-time together with data gathering, and by a request by the central control/processing center 40.

The operations of the bus terminal and the data gathering system using the bus terminal will now be described.

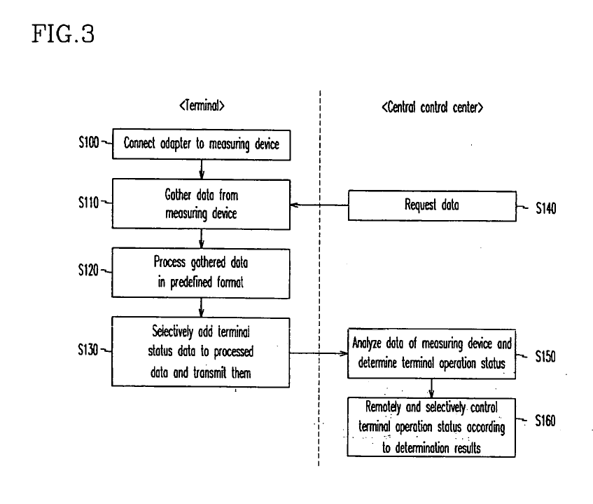

FIG. 3 is a flowchart for a data gathering sequence according to a preferred embodiment of the present invention.

First, as shown, the bus terminal 20 is connected to the measuring device 10 such as a CCD camera, a meteorological sensor, and an environmental sensor through the adapter 21 in step S100. The bus terminal 20 is accordingly equipped with the measuring device 10 and receives measured data from the measuring device 10.

In detail, the data gathering module 221 of the bus terminal 20 gathers measured data from the measuring device 10 according to the control by the control module 224 in step S10. The measured data by measuring device 10 are converted into digital signals by the adapter 21 and provided to the data gathering module 221, and this data gathering procedure is performed by a standardized interface (e.g., an RS232 or an RS422).

The data gathering module 221 stores the measured data provided by the measuring device 10 into the data storing module 222 and provides them according to a transmission command by the central control/processing center 40 later, or provides the measured data to the data processing module 223 to be transmitted in real-time.

The control module 224 operates the data processing module 223 to process the measured data according to the command from the central control/processing center 40, or operates the data processing module 223 for each preset period.

The data processing module 223 is operated by control of the control module 224, and processes the measured data provided from the data gathering module 221 or the measured data stored in the data storing module 222. For example, the data processing module 223 classifies the measured data by criticality and time, and selectively processes the measured data in a specific group. The data processing module 223 processes the measured data, and the state of health data of the measuring device and the bus terminal into a predefined format so as to transmit the data through the RF communications network in step S120.

In this instance for data compatibility, the data format for the system is similar to the data format in a reduced form communicated between a ground control station and a satellite because the data types and amounts gathered are differentiated depending on the measuring devices. For example, the data format includes a header, a variable data packet, a checksum, and a tail for checking validation.

In order to restore the data transmitted from bus terminal into original values, it is desirable for the central control/processing center 40 to have information on the calibration (A/D conversion characteristics information) for analog data and information of a start bit and a bit length for discrete type data and data is processed based on the information (analog/discrete data format and structure information).

The processed measured data in the predefined format are provided to the transmission and reception subsystem 23, the transmission and reception subsystem 23 converts the measured data into RF signals and transmits them to the RF communications network through the antenna 24. In this instance, the state of health data for showing the operation state of the bus terminal can also be processed in the predefined format and transmitted together with the measured data, and it is desirable for the data processing module 223 to generate the state of health data according to control by the control module 224 in step S130.

Sine the data transmission technology through the RF communications network 30 is well known to a person skilled in the art, no further description will be provided.

The central control/processing center 40 transmits a telecommand to the bus terminal 20 through the RF communications network 30 to instruct transmission of measured data in step S140, or receives and analyzes the measured data from the bus terminal 20. In particular, the central control/processing center 40 receives the measured data and the state of health data of the measuring device and the bus terminal from a plurality of bus terminals, and transmits control commands to them. Also, based on the state of health data from each bus terminal, the central control/processing center 40 determine states of the bus terminal and the measuring device, and when any anomaly is found from the bus terminal, the central control/processing center 40 generates an anomaly control command to control the anomalous bus terminals in steps S150 and S160.

As described above, the bus terminal 20 that gathers data from the measuring device 10 and transmits them to the central control/processing center 40 is operated by the power supplied by the battery 251 of the bus terminal or an external power supplier. The battery charge current is supplied by the external power supplier like the solar array. In this case, capacity of the needed battery and the solar array is determined by loads of the bus terminal and the measuring device, and sunlight hours of the bus terminal's installation location.

Detailed description for possible application example of the patent is given but it is not limited. Various changes and modifications based on the concept of the patent defined following claims are belonged to the patent right.

According to the preferred embodiment of the present invention, the data gathered from various distant measuring devices can be easily transmitted on the RF communications network.

In particular, since the measuring device and the data gathering devices transmits the data by using the identical communications system, it is possible to apply the data transmission to other different measuring devices, thereby reducing data transmission costs and providing data compatibility.

Also, it is easy to execute maintenance of the bus terminal and the measuring device because remote control and monitoring is possible. Further, it is allowed to concurrently operate and control many measuring devices and bus terminals in the wide area.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A bus terminal coupled to a central control/processing center through an RF (radio frequency) communications network, comprising:
an adapter coupled to a measuring device, for receiving data measured by the measuring device;
a data processing subsystem for processing the data gathered by the adapter and state of health data of the measuring device and the bus terminal;
a transmission and reception subsystem for transmitting the processed data and control commands for controlling the bus terminal and the measuring device to the central control/processing center through the RF communications network; and
a power supply subsystem for supplying power to the bus terminal.

2. The bus terminal of claim 1, wherein the adapter converts the data provided by the measuring device into digital signals, and provides the digital signals to the data processing subsystem, and receives data from the measuring device through an interface including the RS232 and the RS422.

3. The bus terminal of claim 1, wherein the data processing subsystem comprises:
a data gathering module for gathering the measured data provided by the measuring device through the adapter and the state of health data of the measuring device, and generating state of health data of the bus terminal;
a data storing module for storing the measuring data and the state of health data;
a data processing module for processing the data provided by the data gathering module and the data stored in the data storing module in a predefined format; and
a control module for controlling the data gathering and processing procedures, and controlling the operations of the bus terminal and the measuring device.

4. The bus terminal of claim 3, wherein the control module controls operations of the bus terminal and the measuring device according to telecommands transmitted from the central control/processing center through the RF communications network, controls the transmission and reception subsystem according to a preset period and a request by the central control/processing center, and transmits the processed data to the central control/processing center, and also controls the format of the transmitted data.

5. The bus terminal of claim 1, wherein the power supply subsystem further comprises:
an external power supply module including a solar array for supplying power to the bus terminal;
a battery for supplying power to the bus terminal when the external power supply module supplies no power; and
a power control module for controlling supply of power of the battery and the external power supply, and wherein the external power supply module charges the battery and further comprises a battery for supplying power at the time of power failure and a diode.

6. A bus terminal comprising a transmission and reception subsystem for transmitting data packets of a specific format received from a data processing subsystem to a central control/processing center through an RF (radio frequency) communications network, and transmitting telecommands received from the central control/processing center to a control subsystem of a data processing subsystem.

7. The bus terminal of claim 1, wherein the central control/processing center determines states of the measuring device and the bus terminal based on received state of health data, issues telecommands based on state of health of the bus terminal and the measuring device and processes the telecommands in a predefined format, and transmits the same to the bus terminal through the RF communications network, and the bus terminal accepts the operations executed by the central control/processing center.

8. A data gathering system connected to an RF (radio frequency) communications network, for gathering data measured by a measuring device, comprising:
at least one bus terminal including an adapter for receiving the measured data from the measuring devices, a data processing subsystem for processing the data received by the adapter, a transmission and reception subsystem for transmitting the processed data through the RF communications network and receiving control commands, and a power supply subsystem for supplying electrical power to the bus terminal; and
a central control/processing center connected to the bus terminal through the RF communications network, for receiving the data transmitted from the bus terminal and processing the same.

9. The data gathering system of claim 8, wherein the bus terminal generates state of health data for showing operation states of the bus terminal and the measuring device, and transmits them together with the measured data to the central control/processing center through the RF communications network, and
the central control/processing center monitors states of the bus terminal and the measuring device based on the state of health data, and processes the resultant control telecommands into a predefined format, and transmits the same to the bus terminal through the RF communications network.
